(19) United States
(12) Patent Application Publication
(10) Pub. No.: US 2015/0160255 A1
(43) Pub. Date: Jun. 11, 2015

(54) ROTATION SPEED DETECTION APPARATUS

(71) Applicant: DENSO CORPORATION, Kariya-city (JP)

(72) Inventor: Koichi FUJIHARA, Obu-city (JP)

(21) Appl. No.: 14/557,893

(22) Filed: Dec. 2, 2014

(30) Foreign Application Priority Data
Dec. 6, 2013 (JP) 2013-252955

(51) Int. Cl. G01P 3/487

(52) U.S. Cl. CPC G01P 3/487

(57) ABSTRACT

A rotation speed detection apparatus includes a main rotor, a main magnetic sensor, an auxiliary rotor, an auxiliary magnetic sensor, and a speed increase portion. The main rotor is driven at a rotation speed proportional to a rotation speed of a wheel mounted to a vehicle. The main magnetic sensor magnetically detects a movement of a main magnetic marker positioned along a circumferential direction in the main rotor. The auxiliary rotor is driven at a peripheral speed higher than a peripheral speed of the main rotor and at a rotation speed proportional to the rotation speed of the wheel. The auxiliary magnetic sensor magnetically detects a movement of an auxiliary magnetic marker positioned along a circumferential direction in the auxiliary rotor. The speed increase portion rotatively drives the auxiliary rotor at the peripheral speed higher than the peripheral speed of the main rotor.

### CROSS REFERENCE TO RELATED APPLICATION

This application is based on Japanese Patent Application No. 2013-252955 filed on Dec. 6, 2013, the disclosure of which is incorporated herein by reference.

### TECHNICAL FIELD

The present disclosure relates to a rotation speed detection apparatus detecting a rotation speed of a wheel mounted to a vehicle.

### BACKGROUND

Patent literature 1: JP-A-H7-229756

A rotation speed detection apparatus is widely used for a speedometer mounted to a vehicle such as an automobile. The rotation speed detection apparatus includes a rotation body integrally rotating with a wheel and includes a magnetic sensor detecting a magnetic field that changes with a rotation of the rotation body. Incidentally, the rotation body corresponds to a magnetic drum alternately magnetized at a predetermined pitch in a circumferential direction or a pulse rotor having a projection portion with a gear shape at predetermined intervals, for example. The magnetic sensor corresponds to an MR sensor (e.g. a magnetic sensor using a magnetoresistance effect element) and a Hall sensor (e.g. a magnetic sensor using a Hall element), for example. The magnetic sensor is disposed to a position where a magnetic field changes in the vicinity of the rotation body.

The magnetic sensor has a frequency band that is detectable, and the frequency band of the magnetic sensor generally used in an automobile may be limited to about two orders. For example, when an upper limit of a detectable speed is set to one hundred and several dozens to two hundreds km/h as observed in a common automobile, a lower limit of the detectable speed with a certain level of reliability may be 2 to 3 km/h.

Recently, due to an effort to improve fuel efficiency of the vehicle, a vehicle having an apparatus that stops an engine during a stop by a stoplight for reducing fuel consumption may be widespread. When the vehicle having the above apparatus stops in a steep sloping and a braking is not enough by an unknown reason, the vehicle may go down the sloping at slow speed that is lower than 2 to 3 km/h. Incidentally, a low speed region that is lower than 2 to 3 km/h may be referred to as an extremely low speed region, for example. In a case where a vehicle control system and a driver do not notice this case where the vehicle may go down, the vehicle may hit another vehicle that stops in the vicinity of the vehicle, a guardrail, or the like. The vehicle may deviate from a roadway and may drop into a side ditch or the like.

Patent literature 1 discloses a rotation speed detection apparatus of a wheel. The rotation speed detection apparatus in patent literature 1 enables to detect a speed corresponding to the extremely low speed region, which is less than 2 to 3 km/h. In the rotation speed detection apparatus, a switch is switched over when a rotation speed of the wheel is less than a predetermined value. At a low speed region, a rotation speed measurement based on an output signal from an MR sensor is switched from a detection circuit by a pulse counter to a detection circuit calculating and detecting a change of a phase angle in a unit time.

The applicant of the present disclosure has found the following with respect to a rotation speed detection apparatus.

The rotation speed detection apparatus in patent literature 1 requires the detection circuit calculating and detecting the change of the phase angle in a unit time. That is, the rotation speed detection apparatus requires an additional circuit whose function and configuration is different from a conventional rotation speed detection apparatus. In addition, since the detection circuit in patent literature 1 corresponds to a differentiation circuit, a part including a sensor in addition to the circuit itself may be vulnerable to an electromagnetic noise.

### SUMMARY

It is an object of the present disclosure to provide a rotation speed detection apparatus detecting a rotation speed of a wheel with a magnetic sensor even when a vehicle speed corresponds to an extremely low speed region.

A rotation speed detection apparatus includes a main rotor, a main magnetic sensor, an auxiliary rotor, an auxiliary magnetic sensor, and a speed increase portion. The main rotor is driven at a rotation speed proportional to a rotation speed of a wheel mounted to a vehicle. The main magnetic sensor magnetically detects a movement of a main magnetic marker positioned along a circumferential direction in the main rotor. The auxiliary rotor is driven at a peripheral speed higher than a peripheral speed of the main rotor and at a rotation speed proportional to the rotation speed of the wheel. The auxiliary magnetic sensor magnetically detects a movement of an auxiliary magnetic marker positioned along a circumferential direction in the auxiliary rotor. The speed increase portion rotatively drives the auxiliary rotor at the peripheral speed higher than the peripheral speed of the main rotor.

According to the rotation speed detection apparatus in the present disclosure, it is possible to detect the rotation speed of the wheel with magnetic sensors even when the vehicle speed corresponding to an extremely low speed region. In addition, even when the vehicle speed corresponds to the further extremely low speed region, corresponding to a case where a speed precision is inadequate, it is possible to detect whether the vehicle moves or nor as long as a vehicle moves at a certain speed. It may be possible to prevent an accident at the time of stop in a sloping or the like.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an external perspective view schematically illustrating a configuration of a rotation speed detection apparatus in a first embodiment;

FIG. 2 is a side view schematically illustrating a configuration of the rotation speed detection apparatus in the first embodiment;

FIG. 3 is an elevation cross sectional view schematically illustrating a configuration of the rotation speed detection apparatus taken along line III-III in FIG. 2;

FIG. 4 is a drawing illustrating a configuration including a signal switching unit in the first embodiment;

FIG. 5 is a drawing illustrating a configuration including a signal separation unit in a first modification of the first embodiment;

FIG. 6 is a drawing schematically illustrating a configuration of the rotation speed detection apparatus in a second embodiment;

FIG. 7 is a drawing schematically illustrating a configuration of the rotation speed detection apparatus in a third embodiment;

FIG. 8 is an external perspective view schematically illustrating a configuration of a rotation speed detection apparatus in a fourth embodiment;

FIG. 9 is a side view schematically illustrating a configuration of the rotation speed detection apparatus in the fourth embodiment;

FIG. 10 is an elevation cross sectional view schematically illustrating a configuration of the rotation speed detection apparatus taken along line X-X in FIG. 9;

FIG. 11 is an external perspective view schematically illustrating a configuration of a rotation speed detection apparatus in a fifth embodiment;

FIG. 12 is an elevation view schematically illustrating a configuration of the rotation speed detection apparatus in the fifth embodiment; and

FIG. 13 is a drawing illustrating a configuration including a signal switching unit in the fifth embodiment.

### DETAILED DESCRIPTION

### First Embodiment

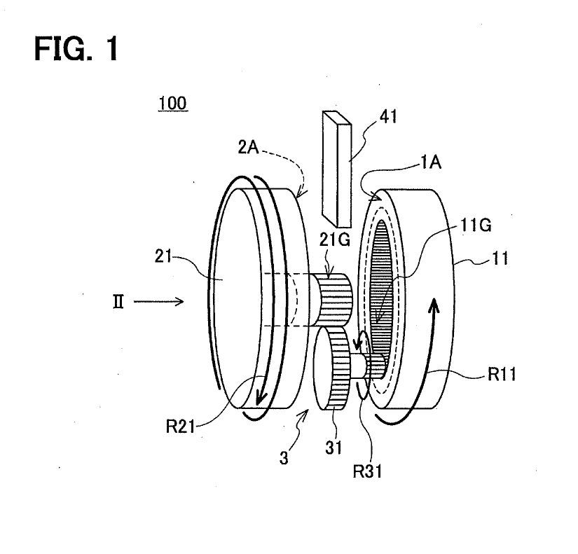

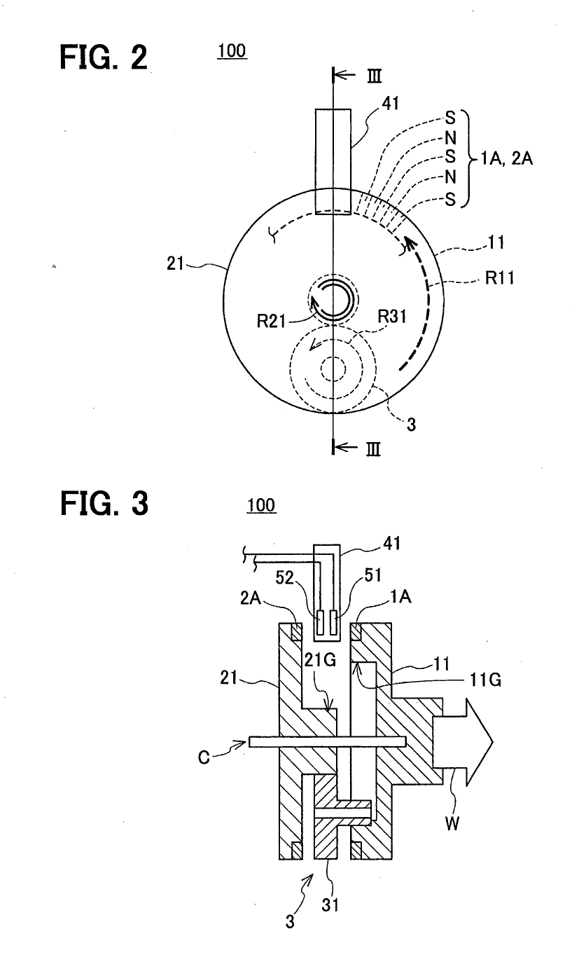

A rotation speed detection apparatus 100 as a first embodiment of the present disclosure will be explained with referring to the drawings. The rotation speed detection apparatus 100 includes a rotor 11 provided with a magnetic marker 1A and a magnetic sensor 51 magnetically detecting a movement of the magnetic marker 1A as described in FIG. 1 to FIG. 4. The magnetic marker 1A is provided along a circumferential direction in one end face of an outer edge in the rotor 11. The rotation speed detection apparatus 100 further includes an auxiliary rotor 21 provided with an auxiliary magnetic marker 2A, an auxiliary magnetic sensor 52, and a speed increase portion 3. The auxiliary magnetic marker 2A is provided along a circumferential direction in one end face of an outer edge in the auxiliary rotor 21. The auxiliary magnetic sensor 52 magnetically detects a movement of the auxiliary magnetic marker 2A.

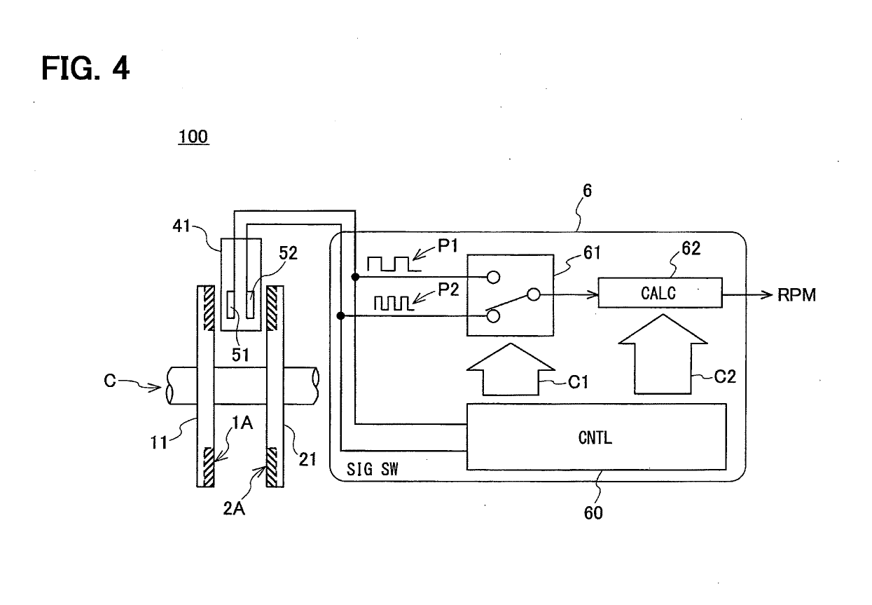

In addition, as described in FIG. 4, the rotation speed detection apparatus 100 includes a signal switching unit 6 that processes pulse signals P1, P2 inputted from the magnetic sensor 51 and the auxiliary magnetic sensor 52 respectively and calculates a rotation speed of a wheel. The signal switching unit 6 receives a low frequency pulse signal P1 from the magnetic sensor 51 and a high frequency pulse signal P2 from the auxiliary magnetic sensor 52, observes the both signals P1, P2 and calculates the rotation speed of the wheel based on the high frequency pulse signal P2 at an extremely low speed region, which is predetermined.

Incidentally, the extremely low speed region corresponds to a speed region that is less than about 3 km/h.

As described in FIG. 1 to FIG. 3, the rotor 11 is mechanically fixed to an axle or the like of the wheel mounted to a vehicle and corresponds to a rotation body that is driven at the identical rotation speed with the rotation speed of the wheel. In FIG. 3, an arrow W represents that the rotor 11 is mechanically fixed to the wheel. The magnetic marker 1A is provided in the vicinity of the end face in the outer edge facing the auxiliary rotor 21 in the rotor 11 in a hollow ring shape with a predetermined width. The magnetic marker 1A corresponds to a magnetic disc portion with a predetermined width. The magnetic marker 1A is magnetized so that magnetic poles are alternately changed with a predetermined pitch along the circumferential direction.

As described in FIG. 3 and FIG. 4, the magnetic sensor 51 corresponds to a Hall sensor. The magnetic sensor 51 detects a variation of a magnetic field caused by the magnetic marker 1A using a Hall element (not shown), detects a rotational movement of the rotor 11 magnetically, and outputs a pulse signal.

The auxiliary rotor 21 corresponds to a rotation body. The auxiliary rotor 21 is driven at a rotation speed proportional to the rotation speed of the wheel at a peripheral speed higher than the peripheral speed of the rotor 11. The auxiliary magnetic marker 2A is provided in the vicinity of the outer edge of the end face facing the rotor 11 in the auxiliary rotor 21 with a hollow ring shape with a predetermined width, similar to the rotor 11. The auxiliary magnetic sensor 52 corresponds to a sensor magnetically detecting a movement of the auxiliary magnetic marker 2A provided to the auxiliary rotor 21 in the circumferential direction.

As described in FIG. 3, the rotor 11 and the auxiliary rotor 21 correspond to a rotation magnetic disc having the identical diameter. The rotor 11 and the auxiliary rotor 21 are coaxial each other and opposed to each other with a predetermined space. The predetermined space corresponds to a space that magnetic fields of the magnetic markers 1A, 2A have little influence each other and a sensor unit 41 having the both magnetic sensors 51, 52 is inserted between the both makers 1A, 2A.

Therefore, the magnetic marker 1A of the rotor 11 and the auxiliary magnetic marker 2A of the auxiliary rotor 21 are adjacently opposed to each other. The sensor unit 41 including the magnetic sensor 51 and the auxiliary magnetic sensor 52 is disposed to a space between the magnetic marker 1A and the auxiliary magnetic marker 2A. That is, the magnetic sensor 51, which is disposed opposed to the magnetic marker 1A, and the auxiliary magnetic sensor 52, which is disposed opposed to the auxiliary magnetic marker 2A, are included into the sensor unit 41 back to back.

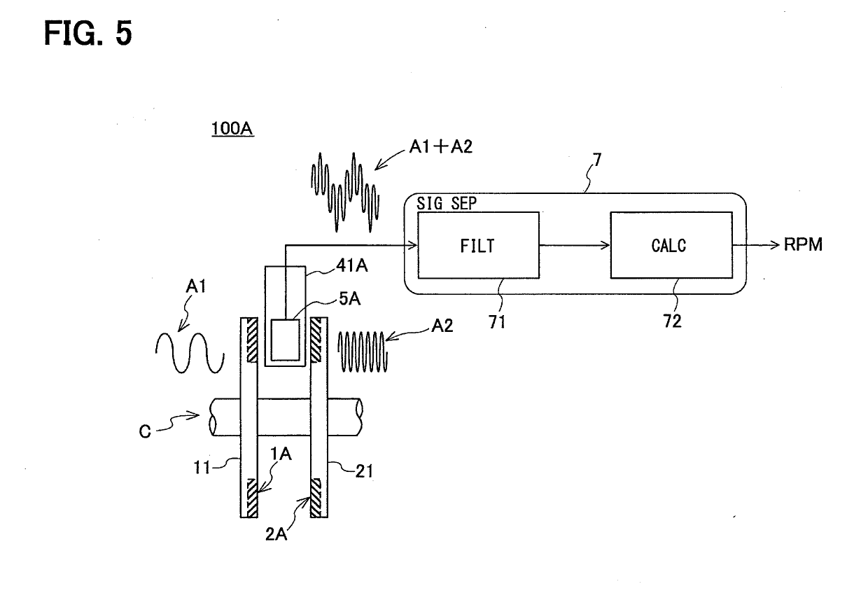

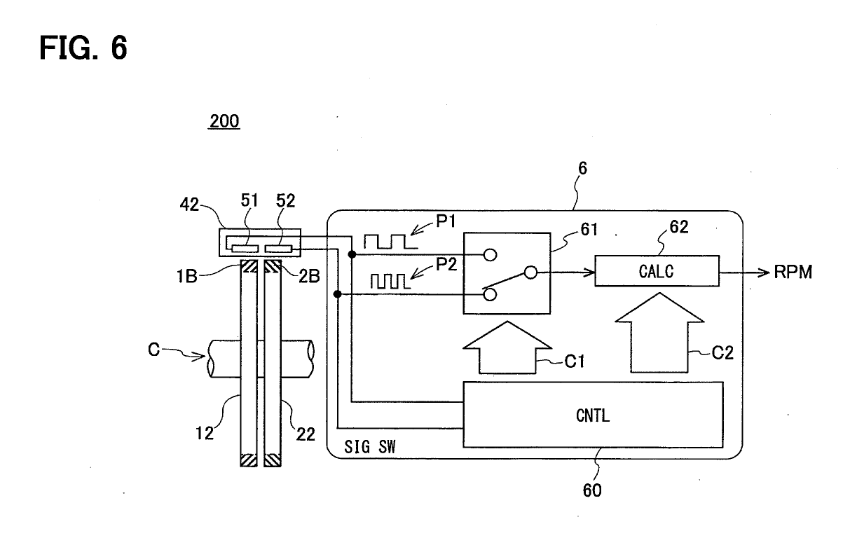

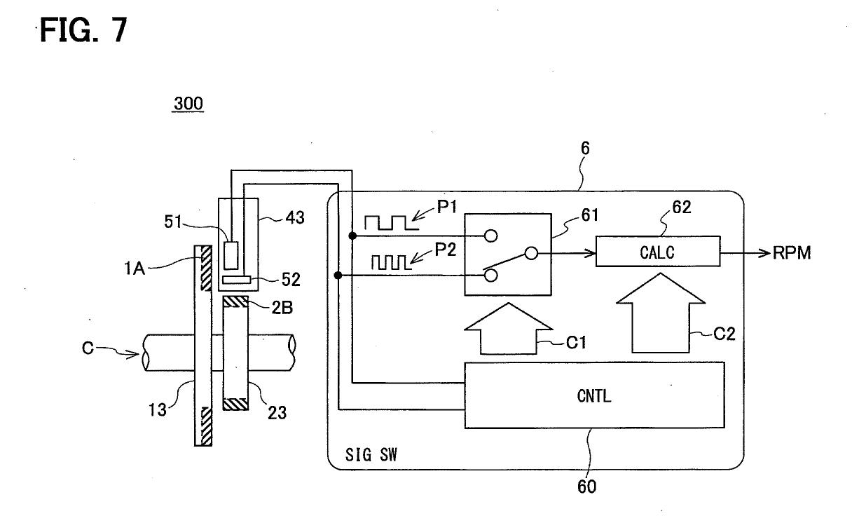

The speed increase portion 3 corresponds to a gear speed increase device, and transmits a rotation of the rotor 11, which integrally rotates with the wheel W, to a spur gear 21G provided at an axis of the auxiliary rotor 21 from an internal gear 11G provided at the rotor 11 through an intermediate gear 31. When all gears used in the speed increase portion 3 are helical gears, a meshing noise during travelling may become quieter. Incidentally, a symbol C in FIG. 3, FIG. 4, FIG. 5, FIG. 6 and FIG. 7 represents a rotation center of the rotor 11 and the auxiliary rotor 21 schematically.

Incidentally, arrows R11, R21, R13 along the circumferential direction in FIG. 1 to FIG. 3 represent a rotational direction and a rotation speed of the rotor 11, the auxiliary rotor 21, and the intermediate gear 31, respectively qualitatively. In other drawings of other embodiments, the same description manner will be used similarly.

Since the diameters of the rotor 11 and the auxiliary rotor 21 are the same, a speed increase ratio between the rotor 11 and the auxiliary rotor 21 corresponds to a multiplying factor of a peripheral speed as it is and corresponds to the speed increase ratio of a tangential speed along the circumferential direction of the auxiliary magnetic marker 2A to a tangential speed along a circumferential direction of the magnetic marker 1A. In the present embodiment, the speed increase ratio is set up to 30 times, for example, and a gear will be designed.

Incidentally, when the speed increase ratio is set up to 30 times, it is possible to measure a speed of 0.1 km/h in a common automobile with a practical reliability. In addition, it is suitable to switch over a magnetic sensor signal smoothly between the extremely low speed region less than 3 km/h and a normal speed region that is equal to or more than 3 km/h.

It is supposed that the normal speed region corresponds to a speed region of 3 km/h to 180 km/h in the present embodiment, for example. In this case, a ratio of an upper limit to a lower limit is equal to 60 times. As mentioned above, the lower limit corresponds to 3 km/h. When a speed region between 3 km/h and 6 km/h that corresponds to twice of the lower limit is overlapped and a measurement portion for the extremely low speed region enables to measure a speed between 3 km/h to 6 km/h, it is possible to switch a speed measurement portion smoothly in the speed range between 3 km/h and 6 km/h.

In other words, even when the speed is reduced to 1/60 of a measurement upper limit with reliability in the extremely low speed region, it is supposed that the speed is measured with practical precision. In this case, a lower limit of a measurable speed corresponds to 0.1 km/h, that is, about 28 mm/s (corresponding to almost 3 cm/s). Therefore, it may be considered that an overlapping of the speed region between 3 km/h and 6 km/h is appropriate. The 1/60 of the measurement upper limit corresponds to an inverse number of sixty times. In addition, it may be possible to detect a movement at further extremely low speed, which is slightly lower than the extremely low speed, when the speed is lower than 0.1 km/h although the speed are not measured.

A range of a suitable multiplying factor of the peripheral speed of the auxiliary magnetic marker 2A to the peripheral speed of the magnetic marker 1A is set from a half (corresponding to a lower value) to twice (corresponding to an upper value) considering a case where a band width of a measurement range is expanded according to an improvement of a sensor performance or considering a case where a smoothness of switchover is reduced. In the present embodiment, about 30 times of the speed increase ratio may be appropriate. It may be considered that the range of the speed increase ratio of a desirable peripheral speed corresponds to between 15 times and 60 times during design.

In other words, it may be preferable that a tangential speed along a circumferential direction of the auxiliary magnetic marker corresponds to 15 times to 60 times of a tangential speed along a circumferential direction of the main magnetic marker.

As described in FIG. 4, the signal switching unit 6 corresponds to a signal processing unit calculating a rotation speed of the wheel based on the low frequency pulse signal P1 and the high frequency pulse signal P2, which are obtained from the magnetic sensor 51 and the auxiliary magnetic sensor 52 respectively. The signal switching unit 6 includes a control portion 60, a switch 61, and a calculation portion 62, which are mainly made from a semiconductor. The signal switching unit 6 observes the high frequency signal P2 and the low frequency signal P1 and calculates the rotation speed of the wheel based on the high frequency signal P2 at the extremely low speed region, which is less than 3 km/h.

The effect of the present embodiment will be described.

As described above, according to a combination of the magnetic sensor 51 and the rotor 11 to which the magnetic marker 1A is provided, it is possible to count the low frequency pulse signal P1 from the magnetic sensor 51 and to measure the rotation speed (that is, a vehicle speed) of the wheel with practical precision in a vehicle at a speed region of about 3 km/h or more. In addition, according to a combination of the auxiliary magnetic sensor 52 and the auxiliary rotor 21 to which the auxiliary magnetic marker 2A is provided, the auxiliary rotor 21 rotates at a high speed corresponding to 30 times of the magnetic marker 1A of the rotor 11 by a function of the speed increase portion 3. Thus, it is possible to obtain pulse signals at a frequency of 30 times of the magnetic sensor 51 from the auxiliary magnetic sensor 52 and to measure the speed of the wheel with practical precision within a predetermined range when the vehicle speed is less than 3 km/h, which corresponds to the extremely low speed region.

More specifically, the control portion 60 observes the signals P1, P2 inputted to the signal switching unit 6, and outputs switching instruction signals C1, C2 to the switch 61 and the calculation portion 62 respectively when the vehicle speed decreases to 3 km/h from a higher speed region, which is equal to or more than 3 km/h. In this case, an output of the switch 61 is switched from the low frequency pulse signal P1 to the high frequency pulse signal P2. The calculation portion 62 receives the high frequency pulse signal P2 in which the frequency (a pulse frequency) is increased 30 times and calculates the rotation speed of the wheel to 1/30.

In a speed region that the vehicle speed is less than 3 km/h, the rotation speed of the wheel is calculated based on the high frequency pulse signal P2. Therefore, it is possible to detect the speed with practical precision at the vehicle speed of 0.1 km/h or more. In addition, in a speed region that is less than 0.1 km/h, it is possible that the vehicle slowly moves.

When the speed increases from the extremely low speed region, the control portion 60 observes the low frequency pulse signal P1 and the high frequency pulse signal P2, and the vehicle speed reaches 6 km/h, the control portion 60 gives the switching instruction signals C1, C2 to the switch 61 and the calculation portion 62 respectively. In this case, the output of the switch 61 is switched from the high frequency pulse signal P2 to the low frequency pulse signal P1. The calculation portion 62 calculates the rotation speed of the wheel, which is increased 30 times, based on the low frequency pulse signal P1. Accordingly, it is possible to perform a rotation speed detection of a wheel for detecting the vehicle speed with practical precision before the vehicle speed reaches 180 km/h.

The switching between the signals P1, P2 is performed at 3 km/h when the vehicle speed decreases and the switching between the signals P1, P2 is performed at 6 km/h when the vehicle speed increases, since an effect corresponding to a chattering is prevented from occurring. Incidentally, in a case where there is a significant difference with respect to the speed detection at the time of the switching between the signals P1, P2, a configuration of the signal switching unit 6 may be changed so that a gradual switching manner is applied, in which a ratio of the rotation speed of the wheel based on the signals P1, P2 is gradually changed between 3 km/h and 6 km/h.

Since the multiplying factor of the peripheral speed of the auxiliary magnetic marker 2A to the peripheral speed of the magnetic marker 1A is properly set up to 30 times in the rotation speed detection apparatus 100 in the present embodiment, it is possible to detect a speed practically at the extremely low speed region of about 0.1 km/h. In addition, at a further extremely low speed region in which a precision of a speed is not secured, it is possible to detect a movement of the vehicle when the vehicle speed reaches a certain level. Therefore, it may be effective to prevent an accident at the time of stop in a sloping or the like. In addition, since the magnetic sensors 51, 52, which are robust and resistant to stain, are applied, the rotation speed detection apparatus 100 is highly reliable.

Therefore, according to the rotation speed detection apparatus in the present embodiment, it is possible to detect the rotation speed of the wheel with the magnetic sensor even when the vehicle speed corresponds to the extremely low speed region, and it is possible to further improve safety at the time of stop in a sloping.

### First Modification in First Embodiment

FIG. 5 describes a first modification of the present embodiment. As described in FIG. 5, a rotation speed detection apparatus 100A may have a single bi-functional magnetic sensor 5A instead of the magnetic sensor 51 and the auxiliary magnetic sensor 52 and a signal separation unit 7 instead of the signal switching unit 6 (referring to FIG. 4). The bi-functional magnetic sensor 5A has functions of the magnetic sensor 51 and the auxiliary magnetic sensor 52.

In the present modification, the space between the rotor 11 and the auxiliary rotor 21 becomes narrower that the first embodiment, and the magnetic fields of the magnetic marker 1A and the auxiliary magnetic marker 2A are overlapped each other so that an overlapped magnetic field is generated. A sensor unit 41A that is thinner than the space is interposed to the space. The bi-functional magnetic sensor 5A includes a single Hall element having a wide dynamic range. In other words, the bi-functional magnetic sensor 5A enables to detect a magnetic field in a wider frequency band. The bi-functional magnetic sensor 5A is positioned to the overlapped magnetic field, and outputs an analog complex waveform signal A1+A2 obtained from the overlapped magnetic field. Incidentally, the overlapped magnetic field has 30 times variation of the frequency.

The signal separation unit 7 receiving the complex waveform signal A1+A2 includes a separation filter 71 and a calculation portion 72 in order.

The separation filter 71 receives the complex waveform signal A1+A2 included in an output signal of the bi-functional magnetic sensor 5A. The complex waveform signal A1+A2 is generated by overlapping a low frequency component A1 caused from the magnetic marker 1A and a high frequency component A2 caused from the auxiliary magnetic marker 2A. The separation filter 71 separates the complex waveform signal. A1+A2 into the low frequency component A1 and the high frequency component A2, and detects each frequency. The separation filter 71 notifies the calculation portion 72 of both frequencies after digitalizing.

The calculation portion 72 corresponds to a digital processor. The calculation portion 72 determines which of the frequency components A1, A2 is referred from each frequency of the both signals A1, A2 according to the rotation speed of the wheel and calculates the rotation speed of the wheel. A switching logic between the both of the frequencies in the calculation portion 72 corresponds to the signal switching unit 6 (referring to FIG. 4) in the first embodiment.

### Second Modification of First Embodiment

In the first embodiment, the magnetic marker 1A and the auxiliary magnetic marker 2A are opposed to each other as described in FIG. 3 and FIG. 4. Alternatively, in a second modification of the first embodiment, the rotor and the auxiliary rotor may be opposed to each other in the rotation speed detection apparatus.

In this modification, the magnetic sensor 51 and the auxiliary magnetic sensor 52 are disposed separately. It may be difficult to house the both magnetic sensors 51, 52 into a single sensor unit. However, since the rotor 11 may be adjacently disposed to the auxiliary rotor 21 as compared with the first embodiment, it is possible to downsize the rotation speed detection apparatus in a rotation axis direction. According to the present modification, it may be possible to realize a downsizing and to reduce weight.

Incidentally, in this modification, a configuration corresponding to the first modification of the first embodiment may be applicable.

### Another Modification of First Embodiment

The magnetic sensor 51 and the auxiliary magnetic sensor 52 in the first embodiment correspond to Hall sensors, which are cheap. The magnetic sensor 51 and the auxiliary magnetic sensor 52 may be MR (magneto-resistive) sensors. Alternatively, the magnetic sensor 51 and the auxiliary magnetic sensor 52 may be other types of magnetic sensors according to the need and may be a combination of an MR sensor and a Hall sensor.

The rotor and the auxiliary rotor correspond to a magnetic drum or a magnetic disc that is alternately magnetized in a predetermined pitch in a circumferential direction (i.e. a tangential direction of rotation) generally. The rotor and the auxiliary rotor may be a combination of the magnetic drum and the magnetic disc.

### Second Embodiment

A rotation speed detection apparatus 200 in the second embodiment will be explained with referring to FIG. 6. The rotation speed detection apparatus 200 includes a rotor 12 and an auxiliary rotor 22, which are coaxially disposed similar to the first embodiment. However, the rotor 12 is disposed quite adjacent to the auxiliary rotor 22 as if the rotor 12 is slidably in contact with the auxiliary rotor 22. The rotor 12 and the auxiliary rotor 22 have outer peripheries with the identical diameter. In other words, the rotor 12 is provided with a magnetic marker 1B on the outer periphery, and the auxiliary rotor 22 is provided with an auxiliary magnetic marker 2B on the outer periphery. The magnetic markers 1B, 2B form alternating magnetic fields in a centrifugal direction. Similar to the first embodiment, a speed increase ratio of the auxiliary rotor 22 to the rotor 12 is equal to 30 times. A speed increase portion 3 (not shown) including the rotors 12, 22 and an intermediate gear 31 (not shown) is designed to be interposed to a narrow space between the rotors 12, 22.

The rotation speed detection apparatus 200 includes a sensor unit 42 adjacent to the outer peripheries of the rotors 12, 22. A magnetic sensor 51 and the auxiliary magnetic sensor 52 are arranged in series inside the sensor unit 4 so that the magnetic sensor 51 and the auxiliary magnetic sensor 52 are positioned in parallel with a rotation axis of the rotors 12, 22.

An output from the magnetic sensor 51 corresponds to the pulse signal P1 similar to the first embodiment. An output from the auxiliary magnetic sensor 52 corresponds to the pulse signal P2 similar to the first embodiment. The signals P1, P2 are processed by the signal switching unit 6 similar to the first embodiment, and the rotation speed of the wheel is detected.

Since the rotation speed detection apparatus 200 in the second embodiment is configured as described above, it is possible to obtain effects similar to the first embodiment.

Since the rotor 12 and the auxiliary rotor 22 are disposed quite adjacently as compared with the first embodiment, it may be possible to reduce an apparatus dimension in an axial length direction. It may be possible to reduce a size and weight of the rotation speed detection apparatus. Although the sensor unit 42 is positioned to the outside of the outer periphery of the rotors 12, 22, the sensor unit 42 may not protrude greatly since the sensor unit 42 is originally small.

(First Modification in Second Embodiment)

It is possible to realize a modification corresponding to the first modification of the first embodiment and to obtain effects similar to the first embodiment.

### Third Embodiment

As described in FIG. 7, a rotation speed detection apparatus 300 of the third embodiment has a rotor shape and a sensor arrangement, which corresponds to a combination of the first embodiment and the second embodiment.

That is, the rotor 13 is coaxially disposed with the auxiliary rotor 23. The diameter of the auxiliary rotor 23 is smaller than the diameter of the rotor 13. The rotor 13 is provided with a magnetic marker 1A in a hollow ring shape on an end face of an outer edge similar to the rotor 11 (referring to FIG. 4) in the first embodiment. The auxiliary rotor 23, which has a diameter smaller than the rotor 13, is provided with an auxiliary magnetic marker 2B on an outer periphery similar to the auxiliary rotor 22 (referring to FIG. 6) in the second embodiment. Incidentally, a speed increase portion (not shown) is designed so that a peripheral speed of the auxiliary magnetic marker 2B is equal to 30 times of the peripheral speed of the magnetic marker 1A.

Since the magnetic marker 1A is perpendicularly positioned in the vicinity of the auxiliary magnetic marker 2B, the magnetic fields formed by the both markers 1A, 2B are perpendicular to each other. The magnetic sensor 51 opposed to the magnetic marker 1A and the auxiliary magnetic sensor 52 opposed to the auxiliary magnetic marker 2B are perpendicularly disposed inside a sensor unit 43, and therefore the magnetic sensors 51, 52 are prevented from being affected by the magnetic field of each other.

Incidentally, the signal switching unit 6 is similar to the first embodiment (referring to FIG. 4) and the second embodiment (referring to FIG. 5).

According to the third embodiment, it is possible to obtain effects of the first embodiment and the second embodiment.

(Modifications)

With respect to the rotation speed detection apparatus 300 in this embodiment, it is possible to realize a first modification corresponding to the first modification of the first embodiment.

In a second modification of the third embodiment, the diameter of the rotor 13 may be smaller than the diameter of the auxiliary rotor 23, the magnetic marker 1B instead of the magnetic marker 1A may be provided to the rotor 13, and the auxiliary magnetic marker 2B instead of the auxiliary magnetic marker 2A may be provided to the auxiliary rotor 23. The arrangement between the magnetic sensor 51 and the auxiliary magnetic sensor 52 may be changed accordingly.

In a third modification of the third embodiment, the rotor 13 and the auxiliary rotor 23 may be quite thin truncated cone shapes having the identical diameter, and conical surfaces of the rotor 13 and the auxiliary rotor 23 are adjacently disposed toward each other. Incidentally, a half apex angle of the corn is about 45 degrees. Since the magnetic sensor 51 and the auxiliary magnetic sensor 52 are perpendicularly disposed to each other in the sensor unit, it is possible to obtain effects similar to the present embodiments. In addition, since a dimension and a shape of the outer periphery are identical between the rotor 13 and the auxiliary rotor 23, it is possible to magnetize the magnetic marker and the auxiliary magnetic marker with an identical apparatus and to produce inexpensively.

Incidentally, in the third modification, the conical surfaces of the rotors 13, 23 are disposed toward each other (that is, each of the conical surfaces faces an opposite rotor). The conical surfaces may be disposed back to back.

### Forth Embodiment

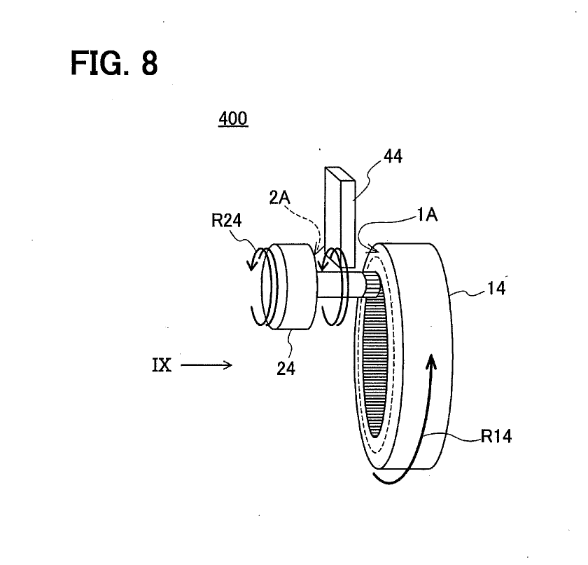

A rotation speed detection apparatus 400 will be explained with referring to FIG. 8 to FIG. 10 as a fourth embodiment. The center of a rotation axis of the rotor 14 and the center of the rotation axis of the auxiliary rotor 24 in the rotation speed detection apparatus 400 are parallel and non-coaxial. A diameter of the auxiliary rotor 24 is smaller than the diameter of the rotor 14. The rotor 14 is provided with a ring-shaped magnetic marker 1A on an end face of an outer edge similar to the rotor 11 in the first embodiment. The auxiliary rotor 24, which is smaller than the rotor 14, is provided with a ring-shaped auxiliary magnetic marker 2A on an end face of an outer edge (referring to FIG. 10).

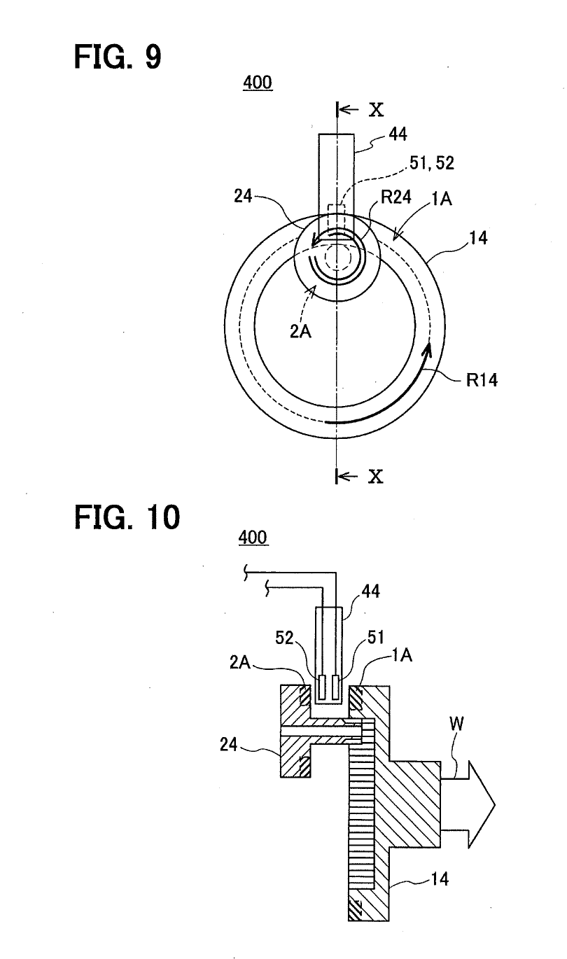

The magnetic marker 1A is opposed to the auxiliary magnetic marker 2A. As described in FIG. 9, a part of the magnetic marker 1A is overlapped and opposed to a part of the auxiliary magnetic marker 2A at a portion where the outer periphery of the rotor 14 is contacted with the outer periphery of the auxiliary rotor 24 viewed from a direction along the rotation axis of the rotor 14. A sensor unit 44 is inserted into the portion where the marker 1A is overlapped with the auxiliary magnetic marker 2A viewed from the direction along the rotation axis of the rotor 14. The sensor unit 44 includes the magnetic sensor 51 and the axially magnetic sensor 52. The magnetic sensor 51 is adjacently opposed to the magnetic marker 1A and the auxiliary magnetic sensor 52 is adjacently opposed to the auxiliary magnetic marker 2A. Incidentally, instead of inserting the sensor unit 44 from an outside of the rotation axis of the rotor 14 along a radius line of the rotor 14, the sensor unit 44 may be inserted from a direction parallel to a tangential direction of the rotor 14 as long as directions of the magnetic sensor 51 and the auxiliary magnetic sensor 52 are remained properly.

The auxiliary rotor 24 is subject to a speed increase drive by an internal gear provided to the rotor 14. That is, the peripheral speed of the auxiliary rotor 24 is increased through a function of the internal gear. The peripheral speed of the auxiliary magnetic marker 2A to the peripheral speed of the magnetic marker 1A is set to 30 times.

Incidentally, in the fourth embodiment, a signal processing apparatus corresponding to the signal switching unit 6 in the first embodiment outputs a measurement value.

According to the rotation speed detection apparatus 400 in the fourth embodiment, similar effects of the first embodiment may be obtained. In addition, in the fourth embodiment, since the auxiliary rotor 24 is small and a configuration of a speed increase portion is simple, it may be possible to realize a downsizing and reduce weight of the rotation speed detection apparatus as compared with the above described embodiments and the modifications.

(Modifications)

With respect to the rotation speed detection apparatus 400, it is possible to realize modifications corresponding to the various modifications of the first embodiment and to obtain corresponding effects. In addition, it is possible to realize modifications corresponding to the second embodiment and the modifications of the second modifications and to obtain corresponding effects.

### Fifth Embodiment

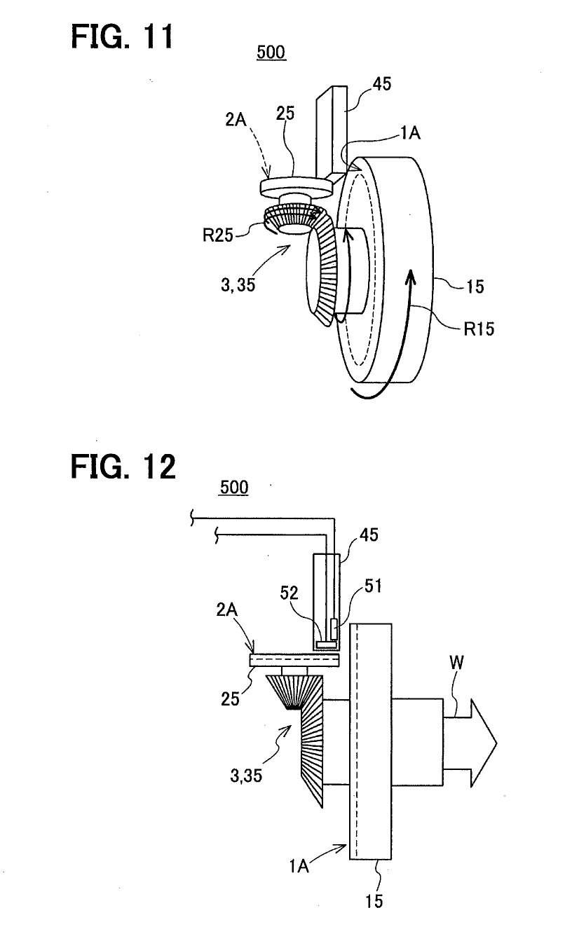

A rotation speed detection apparatus 500 in a fifth embodiment will be explained with referring to FIG. 11 to FIG. 13. The rotation speed detection apparatus 500 has a pair of bevel gears 35 as the speed increasing portion 3, which transmits a rotation of the rotor 15 and increases the speed of the auxiliary rotor 25. As described in FIG. 11, the diameter of the auxiliary rotor 25 is smaller than the diameter of the rotor 15 and the rotation axes of the rotor 15 and the auxiliary rotor 25 are perpendicular to each other.

One end face of the outer edge of each of the rotor 15 and the auxiliary rotor 25 is magnetized in a ring shape to provide a magnetic marker 1A and the auxiliary magnetic marker 2A. The peripheral speed of the auxiliary magnetic marker 2A to the peripheral speed of the magnetic marker 1A is set to 30 times.

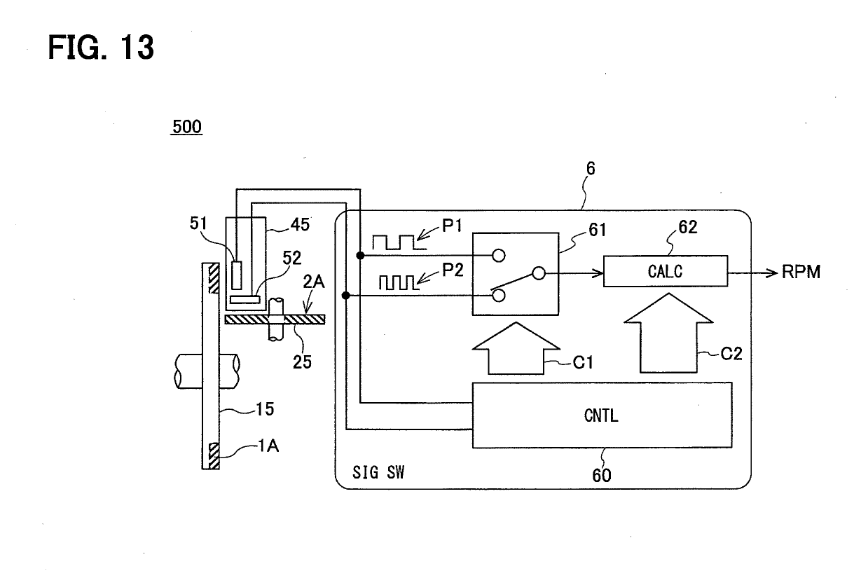

A magnetized surface of the magnetic marker 1A is perpendicular to a magnetized surface of the auxiliary magnetic marker 2A. A part of the magnetic marker 1A is in the vicinity of a part of the auxiliary magnetic marker 2A. The magnetic sensor 51 and the auxiliary magnetic sensor 52, which are perpendicular to each other, are arranged opposed to the magnetic marker 1A and the auxiliary magnetic marker 2A respectively. As described in FIG. 12 and FIG. 13, the magnetic sensor 51 and the auxiliary magnetic sensor 52 are arranged within a sensor unit 45. Incidentally, the sensor unit 45 is not only inserted from a direction perpendicular to a rotation surface of the auxiliary rotor 25, the sensor unit 45 may be inserted from a direction perpendicular to a rotation surface of the rotor 15 or may be inserted from a common tangential direction to the rotor 15 and the auxiliary rotor 25 as long as a position and a direction of the magnetic sensor 51 and the auxiliary magnetic sensor 52 are set properly.

As described in FIG. 13, the fifth embodiment applies the signal switching unit 6 similar to the first embodiment.

The effects similar to the first embodiment or the like are obtained in the fifth embodiment.

(Modifications)

In a first modification of the fifth embodiment, the signal separation unit 7 may be included for processing the analog complex wave form signal A1+A2 as similar to the first modification in the first embodiment with respect to the magnetic sensors 51, 52, and the signal switching unit 6.

In the fifth embodiment, it is possible to comparatively arbitrarily select a combination of the magnetic markers 1A, 1B and the auxiliary magnetic markers 2A, 2B. It may be possible that positional relations and dimensions of the rotors 15, 25 are set appropriate for each of a combination. Any combination may obtain the effects similar to the first embodiment substantially.

A rotation speed detection apparatus in the present disclosure includes a rotor having a magnetic marker provided along a circumferential direction and a magnetic sensor magnetically detecting a movement of the magnetic marker. The rotor corresponds to a rotation body driven at a rotation speed that is proportional to a rotation speed of a wheel mounted to a vehicle. The magnetic marker is provided to an outer periphery of the rotor, an end face in the vicinity of an outer edge, or the like. The magnetic sensor magnetically detects the movement of the magnetic marker and responds to an intensity of a magnetic field, a time rate of change of the magnetic field, or the like applied to the magnetic sensor.

In addition, the rotation speed detection apparatus further includes an auxiliary rotor having the auxiliary magnetic marker provided along a circumferential direction, an auxiliary magnetic sensor magnetically detecting the movement of the auxiliary magnetic marker, and a speed increase portion.

The auxiliary rotor corresponds to a rotation body and is driven at a rotation speed proportional to the rotation speed of the wheel at a peripheral speed higher than the peripheral speed of the rotor. The auxiliary magnetic marker is provided to an outer periphery of the auxiliary rotor, an end face in the vicinity of the outer edge or the like. The auxiliary magnetic sensor magnetically detects the movement of the auxiliary magnetic marker provided along the circumferential direction of the auxiliary rotor. The speed increase portion rotatively drives the auxiliary rotor at a peripheral speed higher than the peripheral speed of the rotor.

Incidentally, it should be noted that the present disclosure does not exclude a configuration having third or more rotors in addition to the auxiliary rotor.

The rotation speed detection apparatus has the following effects, for example.

According to a combination of the rotor provided with the magnetic marker and the magnetic sensor, it is possible to measure a rotation speed (that is, a vehicle speed) of a wheel with practical precision in a vehicle in a speed region of about 3 km/h or more by counting or the like a pulse signal from the magnetic sensors. According to a combination of the auxiliary rotor provided with the auxiliary magnetic marker and the auxiliary magnetic sensor, the auxiliary magnetic marker of the auxiliary rotor rotates at the peripheral speed higher than the peripheral speed of the magnetic marker of the rotor. Therefore, it is possible to measure a rotation speed of the wheel with practical precision in a predetermined range in the extremely low speed region where the vehicle speed corresponds to about 3 km/h or less.

Incidentally, when a multiplying factor of the peripheral speed of the auxiliary magnetic marker to the peripheral speed of the magnetic marker is appropriate, it is possible to measure the speed of a vehicle practically even in a further extremely low speed region, for example, about 0.1 km/h or less.

Therefore, according the rotation speed detection apparatus in the present disclosure, it is possible to detect the rotation speed of the wheel with magnetic sensors even when the vehicle speed corresponding to the extremely low speed region. In addition, even when the vehicle speed corresponds to the further extremely low speed region corresponding to a case where a speed precision is inadequate, it is possible to detect whether the vehicle moves or nor as long as a vehicle moves at a certain speed. It may be possible to prevent an accident at the time of stop in a sloping or the like.

Incidentally, the rotors 11 to 15 corresponding to the magnetic drum and the magnetic disc correspond to a rotor. The auxiliary rotors 21 to 25 corresponding to the magnetic drum and the magnetic disc correspond to an auxiliary rotor.

Incidentally, the rotors 11 to 15 may be referred to as a main rotor, the magnetic markers 1A, 1B may be referred to as a main magnetic marker, and the magnetic sensor 51 may be referred to as a main magnetic sensor in the present disclosure.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A rotation speed detection apparatus comprising:
a main rotor driven at a rotation speed proportional to a rotation speed of a wheel mounted to a vehicle;
a main magnetic sensor magnetically detecting a movement of a main magnetic marker positioned along a circumferential direction in the main rotor;
an auxiliary rotor driven at a peripheral speed higher than a peripheral speed of the main rotor and at a rotation speed proportional to the rotation speed of the wheel;
an auxiliary magnetic sensor magnetically detecting a movement of an auxiliary magnetic marker positioned along a circumferential direction in the auxiliary rotor; and
a speed increase portion rotatively drives the auxiliary rotor at the peripheral speed higher than the peripheral speed of the main rotor.

2. The rotation speed detection apparatus according to claim 1, wherein
the main magnetic marker of the main rotor and the auxiliary magnetic marker of the auxiliary rotor are adjacent to each other at an adjacent part in the rotation speed detection apparatus, and
the rotation speed detection apparatus further comprises
a sensor unit disposed to the adjacent part and housing the main magnetic sensor and the auxiliary magnetic sensor.

3. The rotation speed detection apparatus according to claim 1, wherein
the main magnetic marker of the main rotor and the auxiliary magnetic marker of the auxiliary rotor are adjacent to each other at an adjacent part in the rotation speed detection apparatus,
the rotation speed detection apparatus further comprises
a sensor unit disposed to the adjacent part and housing the main magnetic sensor and the auxiliary magnetic sensor,
the main rotor and the auxiliary rotor are coaxially disposed to each other,
the main magnetic marker of the main rotor opposes the auxiliary magnetic marker of the auxiliary rotor having a predetermined space,
the sensor unit is disposed between the main magnetic marker and the auxiliary magnetic marker, and
the main magnetic sensor and the auxiliary magnetic sensor are housed in the sensor unit back to back.

4. The rotation speed detection apparatus according to claim 1, wherein
an outer periphery of the main rotor and an outer periphery of the auxiliary rotor have an identical diameter,
rotation axes of the main rotor and the auxiliary rotor are coaxially disposed,
the main rotor has the main magnetic marker at the outer periphery, and
the auxiliary rotor has the auxiliary magnetic marker at the outer periphery.

5. The rotation speed detection apparatus according to claim 1, wherein
the main rotor and the auxiliary rotor are coaxially disposed to each other,
a diameter of one of the main rotor and the auxiliary rotor is smaller than a diameter of an other of the main rotor and the auxiliary rotor,
the one of the main rotor and the auxiliary rotor has one of the main magnetic marker and the auxiliary magnetic marker at an outer periphery,
the other of the main rotor and the auxiliary rotor has an other of the main magnetic marker and the auxiliary magnetic marker, and
the other of the main magnetic marker and the auxiliary magnetic marker faces toward a direction of the one of the main rotor and the auxiliary rotor in a hollow ring shape.

6. The rotation speed detection apparatus according to claim 1, wherein
a rotation axis of the main rotor is non-coaxial and parallel to a rotation axis of the auxiliary rotor,
a diameter of the auxiliary rotor is smaller than a diameter of the main rotor, and
the auxiliary rotor is subject to a speed increase drive by an internal gear of the main rotor.

7. The rotation speed detection apparatus according to claim 1, wherein
the speed increase portion corresponds to a pair of bevel gears by which the main rotor performs a speed increase drive to the auxiliary rotor.

8. The rotation speed detection apparatus according to claim 1 further comprising
a signal switching unit:
receiving a low frequency signal from the main magnetic sensor and a high frequency signal from the auxiliary magnetic sensor;
observing the low frequency signal and the high frequency signal; and
calculating the rotation speed of the wheel based on the high frequency signal in a predetermined extremely low speed region.

9. The rotation speed detection apparatus according to claim 1 wherein
the main magnetic sensor and the auxiliary magnetic sensor correspond to a single both-function magnetic sensor having functions of the main magnetic sensor and the auxiliary magnetic sensor,
the rotation speed detection apparatus further comprises a signal separation unit including:
a separation filter separating a complex waveform, which is included in an output signal of the both-function magnetic sensor signal, into a low frequency component and a high frequency component, the low frequency component and the high frequency component being overlapped in the complex waveform signal; and
a calculation portion switching which of the low frequency component and the high frequency component is referred for detecting the rotation speed of the wheel according to the rotation speed of the wheel and calculating the rotation speed of the wheel,
the low frequency component is caused by the main magnetic marker, and
the high frequency component is caused by the auxiliary magnetic marker.

10. The rotation speed detection apparatus according to claim 1, wherein
a tangential speed along a circumferential direction of the auxiliary magnetic marker corresponds to 15 times to 60 times of a tangential speed along a circumferential direction of the main magnetic marker.

11. The rotation speed detection apparatus according to claim 8, wherein
the predetermined extremely low speed region corresponds to less than 3 km/h.
